(19) United States
(12) Patent Application Publication
(10) Pub. No.: US 2020/0175446 A1
(43) Pub. Date: Jun. 4, 2020

(54) SYSTEM AND METHOD FOR MANAGING TAXI DISPATCH, AND PROGRAM FOR CONTROLLING TAXI DISPATCH REQUESTS

(71) Applicant: DeNA Co., Ltd., Tokyo (JP)

(72) Inventors: Takayuki KUROSAWA, Tokyo (JP); Ayumu HISADA, Tokyo (JP)

(21) Appl. No.: 16/701,017

(22) Filed: Dec. 2, 2019

(30) Foreign Application Priority Data
Dec. 3, 2018 (JP) 2018-226283

(51) Int. Cl. G06Q 10/06; G06T 13/80; G06F 3/0484

(52) U.S. Cl. CPC G06Q 10/06314; G06F 3/04847; G06T 13/80

(57) ABSTRACT

A dispatch management system 1 according to an embodiment of the present invention comprises a management server 10 and a user terminal 30 that is communicably connected to the server 10 via a communication network 20, and provides a user who operates the user terminal 30 with a taxi dispatch service in which a taxi is dispatched in response to a dispatch request. In this system 1, since the recommended boarding location is set on the basis of the user's current location, the setting of an appropriate boarding location is promoted and, furthermore, a first object for specifying the boarding location is initially displayed at the user's current location in the map display area and is moved along with an animation effect showing the path from the user's current location to the recommended boarding location, and this allows the user to easily ascertain the boarding location that is being recommended.

### CROSS-REFERENCE TO RELATED APPLICATIONS

This application claims foreign priority under 35 USC 119 based on Japanese Patent Application No. JP 2018-226283 filed on Dec. 3, 2018, the contents of which is incorporated herein in its entirety by reference.

### BACKGROUND

### Technical Field

The present invention relates to a system and method for managing taxi dispatch, and to a program for controlling taxi dispatch requests.

### Related Art

Systems for managing taxi dispatch have been proposed in the past (see, for example, Patent Document 1 below). With such a system, typically, when the user makes a dispatch request while specifying the boarding location (the dispatch request location/pickup location), the system searches for and dispatches an empty vehicle traveling in the area near the designated boarding location.

### RELATED ART DOCUMENT

### Patent Documents

[Patent Document 1]: Japanese Patent Application 2018-49408

### SUMMARY

### Problems to be Solved

However, with a conventional system, situations may arise in which it is not easy for the user to specify an appropriate boarding location. For instance, if a dispatch request is made indoors in an area about which the user does not have sufficient geographical knowledge (for example, an area visited for the first time), it will be difficult for the user to know the appropriate place to use as the boarding location. If, as a result of this, the user ends up designating an inappropriate place as the boarding location, such as a place where it is difficult for a taxi to make a temporary stop, or a place where the target vehicle is difficult to find, this can hinder smooth boarding of the dispatched vehicle.

It is an object of the present invention to support smooth boarding of dispatched vehicles. One object of the embodiments of the present invention is to support smooth boarding of a vehicle that has been dispatched. Other objects of the embodiments of the present invention will become apparent by referring to the entire Specification.

### Technical Solution

The system according to an embodiment of the present invention comprises one or more computer processors, and is a system for managing a taxi dispatch, wherein the one or more computer processors, in response to the execution of readable commands, execute processing for presenting a user with a specific screen having a map display area in which is disposed a first object that is used for specifying the user's boarding location and that is initially disposed at the user's current location; setting a first recommended boarding location that is recommended as the user's boarding location on the basis of at least the user's current location, and moving the first object from the user's current location to the first recommended boarding location in the map display area; receiving from the user a taxi dispatch request in which the location of the first object is used as the user's boarding location; and performing specific dispatch processing in response to the receipt of the dispatch request. The processing for moving the first object to the first recommended boarding location includes moving the first object along with an animation effect showing the path from the user's current location to the first recommended boarding location.

The method according to an embodiment of the present invention is a method for managing taxi dispatch, which is executed by one or more computers, said method comprising the steps of presenting a user with a specific screen having a map display area in which is disposed a first object that is used for specifying the user's boarding location and that is initially disposed at the user's current location; setting a first recommended boarding location that is recommended as the user's boarding location on the basis of at least the user's current location, and moving the first object from the user's current location to the first recommended boarding location in the map display area; receiving from the user a taxi dispatch request in which the location of the first object is used as the user's boarding location; and performing specific dispatch processing in response to the receipt of the dispatch request. The step of moving the first object to the first recommended boarding location includes moving the first object along with an animation effect showing the path from the user's current location to the first recommended boarding location.

The program according to an embodiment of the present invention is a program for controlling taxi dispatch requests, said program, in response to being executed on one or more computers, causing the one or more computers to execute processing for presenting a user with a specific screen having a map display area in which is disposed a first object that is used for specifying the user's boarding location and that is initially disposed at the user's current location; for moving the first object in the map display area from the user's current location to a first recommended boarding location that is recommended as the user's boarding location and that is set on the basis of at least the user's current location; and receiving from the user a taxi dispatch request in which the location of the first object is used as the user's boarding location. The processing for moving the first object to the first recommended boarding location includes moving the first object along with an animation effect showing the path from the user's current location to the first recommended boarding location.

### Technical Effect

Various embodiments of the present invention support smooth boarding of a dispatched vehicle.

### BRIEF DESCRIPTION OF THE DRAWINGS

FIG. 1 A configuration diagram schematically showing the network configuration of a dispatch management system 1 according to an embodiment of the present invention.

FIG. 2 A block diagram schematically showing the functions of a management server 10 and a user terminal 30 provided to the system 1.

FIG. 3 A diagram showing an example of the information managed in a user information table 511.

FIG. 4 A diagram showing an example of the information managed in a vehicle information table 512.

FIG. 5 A diagram showing an example of the information managed in a dispatch request information table 513.

FIG. 6 A sequence diagram showing an example of the processing executed by the management server 10 and the user terminal 30.

FIG. 7 A diagram showing an example of a boarding location setting screen 70.

FIG. 8 A diagram illustrating how a boarding location object 722 moves on the boarding location setting screen 70.

FIG. 9 A diagram showing an example of the boarding location setting screen 70 in a state in which the movement of the boarding location object 722 to the recommended boarding location is complete.

FIG. 10 A diagram showing an example of a dispatch request screen 80.

FIG. 11 A diagram showing an example of the boarding location setting screen 70 in a state in which the map display range in the map display area 72 is being changed.

FIG. 12 A sequence diagram showing an example of the processing executed by the management server 10 and the user terminal 30.

FIG. 13 A diagram showing an example of the boarding location setting screen 70 in a state in which a boarding location change has been requested.

FIG. 14 A diagram illustrating how a boarding location object 722 moves on the boarding location setting screen 70.

FIG. 15 A diagram showing an example of the boarding location setting screen 70 in a state in which the movement of the boarding location object 722 to the recommended boarding location is complete.

FIG. 16 A diagram showing an example of the change in appearance of the first object 722A that has separated from the boarding location object 722.

### DETAILED DESCRIPTION

Embodiments of the present invention will now be described with reference to the drawings.

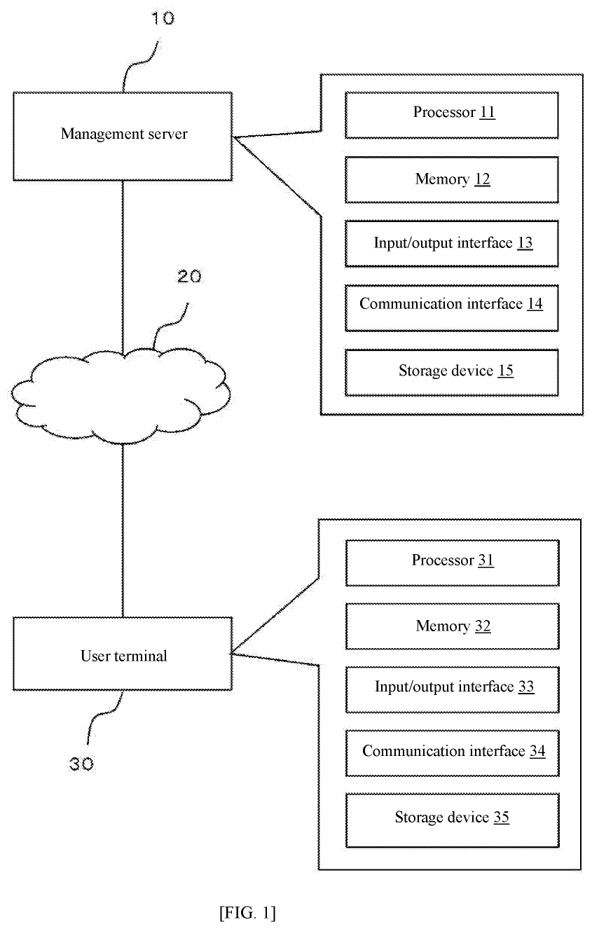

FIG. 1 is a configuration diagram schematically showing the network configuration of a dispatch management system 1 according to an embodiment of the present invention. As shown in the drawing, the system 1 comprises a management server 10 and a user terminal 30 that is communicably connected to this server 10 via a communication network 20 such as the Internet. Although only one user terminal 30 is depicted in FIG. 1, the system 1 comprises a plurality of user terminals 30. The dispatch management system 1 provides the user operating the user terminal 30 with a taxi dispatch service that performs taxi dispatch in response to a dispatch request.

The management server 10 is configured as an ordinary computer and, as shown in FIG. 1, it comprises a computer processor 11 configured as a CPU, a GPU, etc., a main memory 12, an input/output interface 13, a communication interface 14, and a storage device 15. These constituent elements are electrically connected via a bus or the like (not shown).

The computer processor 11 reads various programs stored in the storage device 15 or the like into the main memory 12, and executes various commands included in these programs. The main memory 12 is constituted by a DRAM, for example.

The input/output interface 13 includes various input/output devices for exchanging information with a user or the like. The input/output interface 13 includes, for example, an information input device such as a keyboard or a pointing device (such as a mouse or a touch panel), a voice input device such as a microphone, and an image input device such as a camera. The input/output interface 13 also includes an image output device (display device) and an audio output device such as a speaker.

The communication interface 14 is implemented as hardware such as a network adapter, various communication software, and combinations of these, and is configured so that wired or wireless communication can be realized via the communication network 20 or the like.

The storage device 15 is configured by a magnetic disk or a flash memory, for example. The storage device 15 stores various programs including an operating system, various data, and so forth.

In this embodiment, the management server 10 can be configured using a plurality of computers each having the hardware configuration described above. For instance, the management server 10 can be made up of a plurality of server devices.

In this embodiment, the management server 10 can be configured to function as a web server and an application server. In this case, various kinds of processing are executed in response to a request from a web browser or other application (such as an application for the taxi dispatch service) on the user terminal 30, and screen data (such as HTML data), control data, and so forth are sent to the user terminal 30 according to the result of this processing. A web page or other screen based on the received data is displayed on the user terminal 30.

The user terminal 30 is configured as an ordinary computer and, as shown in FIG. 1, it comprises a computer processor 31, a main memory 32, an input/output interface 33, a communication interface 34, and a storage device 35. These constituent elements are electrically connected via a bus or the like (not shown).

The computer processor 31 is configured as a CPU, GPU, or the like, reads various programs stored in the storage device 35 or the like into the main memory 32, and executes the various commands included in the programs. The main memory 32 is constituted by a DRAM, for example.

The input/output interface 33 includes various input/output devices for exchanging information with the user, etc. The input/output interface 33 includes, for example, an information input device such as a keyboard or a pointing device (such as a mouse or a touch panel), a voice input device such as a microphone, and an image input device such as a camera. The input/output interface 33 also includes an image output device such as a display, and an audio output device such as a speaker.

The communication interface 34 is implemented as hardware such as a network adapter, various types of communication software, and combinations of these, and is configured so as to realize wired or wireless communication via the communication network 20 or the like.

The storage device 35 is constituted by a magnetic disk or a flash memory, for example. The storage device 35 stores various programs including an operating system, various data, and so forth. The programs stored in the storage device 35 can be downloaded from an application market or the like and installed.

In this embodiment, the user terminal 30 can be configured as a smartphone, a tablet terminal, a wearable device, a personal computer, or the like.

The user who operates the user terminal 30 configured as above is able to make use of the taxi dispatch service provided by the system 1 by communicating with the management server 10 via a web browser or other application installed in the storage device 35 or the like.

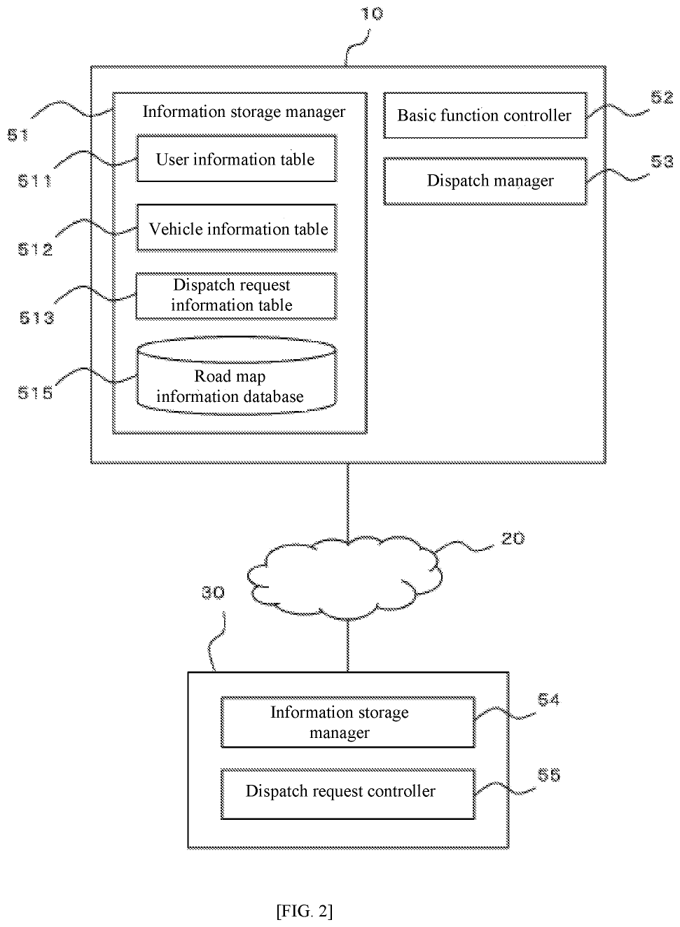

Next, the functions of the dispatch management system 1 in this embodiment will be described. FIG. 2 is a block diagram schematically illustrating the functions of the management server 10 and the user terminal 30 included in the system 1. As shown in the drawing, the management server 10 includes an information storage manager 51 that stores and manages information, a basic function controller 52 that controls the basic functions of the taxi dispatch service, and a dispatch manager 53 that manages taxi dispatch. The functions of these components are realized by the joint operation of hardware such as the computer processor 11 and the main memory 12, and the various programs, data, etc., stored in the storage device 15, etc. For example, these functions are realized when the computer processor 11 executes the commands included in the programs read into the main memory 12. Also, some or all of the functions of the management server 10 shown in FIG. 2 can be realized by the joint operation of the management server 10 and the user terminal 30, or by just the user terminal 30.

As shown in FIG. 2, the user terminal 30 has an information storage manager 54 that stores and manages information, and a dispatch request controller 55 that controls dispatch requests from users. The functions of these components are realized by the joint operation of hardware such as the computer processor 31 and the main memory 32, and various programs, data, etc., stored in the storage device 35, etc. For example, these functions are realized when the computer processor 31 executes the commands included in the programs read into the main memory 32. Also, some or all of the functions of the user terminal 30 shown in FIG. 2 can be realized by the joint operation of the management server 10 and the user terminal 30, or by just the user terminal 30.

The information storage manager 51 of the management server 10 is constituted by the storage device 15, etc., and stores and manages various kinds of information. For example, as shown in FIG. 2, the information storage manager 51 can have a user information table 511 that manages information related to users of the taxi dispatch service, a vehicle information table 512 that manages information related to the vehicles (taxis) to be dispatched in the taxi dispatch service, a dispatch request information table 513 that manages information related to dispatch requests from users, and a road map information database 515 that holds various information related to road maps (including road network data).

The basic function controller 52 of the management server 10 executes various processing related to the control of the basic functions of the taxi dispatch service. For instance, the basic function controller 52 transmits the screen data or control data for various screens related to the basic functions to the user terminal 30, executes various processing in response to user input via the screen displayed on the user terminal 30, and transmits screen data or control data corresponding to the result of the processing to the user terminal 30. The basic functions controlled by the basic function controller 52 include, for example, login processing (user authentication), payment processing, user management (such as updating the user information table 511), vehicle management (such as updating the vehicle information table 512), and the like.

The dispatch manager 53 of the management server 10 executes various processing related to the management of taxi dispatch. For example, the dispatch manager 53 transmits screen data or control data for various screens related to the management of dispatch to the user terminal 30, executes various processing in response to user input via the screen displayed on the user terminal 30, and transmits screen data or control data corresponding to the result of the processing to the user terminal 30. The dispatch manager 53 can be configured to exchange various information with an information processing terminal operated by a taxi driver.

The information storage manager 54 of the user terminal 30 includes the storage device 35, etc., and stores and manages various information. For example, the information storage manager 54 may be configured to store information related to road maps that are transmitted from the management server 10.

The dispatch request controller 55 of the user terminal 30 executes various processing related to the control of taxi dispatch requests. For example, the dispatch request controller 55 is configured to display various screens related to the control of dispatch requests on the user terminal 30, receive operation inputs made by the user via these screens, and transmit information related to dispatch requests to the management server 10.

In this embodiment, the dispatch request controller 55 is configured to present a user with specific screen having a map display area in which is disposed a first object that is used to specify the user's boarding location. This first object is initially disposed at the user's current location. For example, the dispatch request controller 55 is configured so that the specific screen is displayed on the user terminal 30 in response to an instruction to start a taxi dispatch request from the user (for example, in response to the launch of a taxi dispatch service application) and the first object is initially disposed at the user's current location in the map display area of this specific screen.

The dispatch manager 53 of the management server 10 is also configured to set a recommended boarding location that is recommended as the boarding location of the user on the basis of at least the user's current location, and transmit this recommended boarding location to the user terminal 30. The dispatch request controller 55 of the user terminal 30 is configured to move the first object from the user's current location (initially disposed) to the recommended boarding location received from the management server 10, in the map display area of the above-mentioned specific screen. For example, the dispatch manager 53 is configured to acquire location information about the user terminal 30, as the user's current location, from the user terminal 30 in response to a request from the user terminal 30 to set the recommended boarding location, and to set the recommended boarding location on the basis of the acquired current location.

In this embodiment, the first object is configured so that when it is moved from the user's current location to the recommended boarding location, it moves along with an animation effect showing the path from the user's current location to the recommended boarding location. For example, the map display area of a specific screen is configured such that the first object moves along with this animation effect. For example, various animation displays can be performed such that the first object moves along a linear or curved path in which the user's current location is the starting point and the recommended boarding location is the end point.

Also, the dispatch request controller 55 of the user terminal 30 is configured to receive from the user a taxi dispatch request in which the location of the first object in the map display area serves as the user's boarding location, and to transmit this dispatch request to the management server 10, and dispatch manager 53 of the management server 10 is configured to perform specific dispatch processing in response to the reception of this dispatch request. For instance, the dispatch request controller 55 is configured to receive a dispatch request in which the location of the first object is the boarding location, when the user uses the above-mentioned specific screen or another screen to indicate a dispatch request. The specific dispatch processing performed by the dispatch manager 53 of the management server 10 is not limited to the above, and includes, for example, processing to transmit dispatch request information to a dispatch vehicle selected from among a plurality of taxis, and processing to receive from a dispatch vehicle a response to a dispatch request (accept or decline).

Thus, with the dispatch management system 1 in this embodiment, since the recommended boarding location is set on the basis of the user's current location, the setting of an appropriate boarding location is promoted and, furthermore, in the map display area of the specific screen presented to the user, the first object for specifying the boarding location is initially displayed at the user's current location and moves along with an animation effect showing the path from the user's current location to the recommended boarding location, which means that the user can easily ascertain the boarding location that is recommended. This fosters smooth boarding of the dispatched vehicle.

In this embodiment, the recommended boarding location that is recommended as the boarding location for the user can be set using various methods. For example, the dispatch manager 53 of the management server 10 is configured to calculate the closest roadway (link) from the user's current location and to set a location near this roadway as the recommended boarding location, or, if a preset recommended boarding location candidate (for example, based on past setting results of boarding locations in the taxi dispatch service) is within a specific range from the user's current location, then it is configured so that this candidate is set as the recommended boarding location.

In this embodiment, in setting the recommended boarding location, the dispatch time that will be required to dispatch a taxi to the recommended boarding location (how long it will take for the taxi to arrive at the recommended boarding location) may be estimated. For example, the dispatch manager 53 of the management server 10 may be configured to calculate an estimated dispatch time on the basis of at least the recommended boarding location that has been set. In this case, the estimated dispatch time that has been calculated can be displayed on the above-mentioned specific screen (for example, in the map display area) along with the movement of the first object to the recommended boarding location (such as during the movement or after the movement). For instance, the configuration may be such that the dispatch manager 53 of the management server 10 transmits the calculated estimated dispatch time to the user terminal 30, and the dispatch request controller 55 of the user terminal 30 displays the estimated dispatch time received from the management server 10 at a location, for example, close to the first object, along with the movement of the first object to the recommended boarding location. Such a configuration makes it possible to present the estimated dispatch time together with the recommended boarding location to the user in advance.

In this embodiment, the above-mentioned specific screen may be configured such that the location of the first object on the map can be changed according to an operation by the user. For example, the specific screen is configured such that when the location of the first object in the map display area is changed, or when the location of the first object in the map display area is left alone and the range/portion (area) of the map displayed in the map display area is changed, the location of the first object on the map is changed. Such a configuration makes it easy to change the boarding location through changing the location of the first object on the map.

Also, the specific screen may be configured such that the location of the first object cannot be changed when the changed location of the first object is included in a first area. This first area could also be called an area in which setting as a boarding location is prohibited (such as in the middle of an intersection). For example, the specific screen is configured such that if the user tries to move the first object inside the first area, a specific prohibition display (a display of a message, a change in the appearance of the first object, etc.) is performed, and the location of the first object goes back to where it was before the change. Such a configuration prevents the boarding location from being set inside an area where setting as the boarding location is prohibited.

The specific screen may also be configured such that a specific warning is given to the user if the changed location of the first object is included in a second area. This second area could also be called an area where setting as a boarding location would be inappropriate (undesirable) (such as on a steeply sloped road). For example, the specific screen is configured such that if the user tries to change the first object to a specific location within the second area, a specific warning display is performed (the display of a message, a change in the appearance of the first object, etc.), and the location of the first object is changed to the specific location within the second area, either with or without confirmation input by the user. Such a configuration makes it less likely that the boarding location will be set to an area where setting as the boarding location would be inappropriate.

In this embodiment, a new recommended boarding location may be set every time the location of the first object on the map is changed according to an operation by the user. For instance, the dispatch request controller 55 of the user terminal 30 may be configured such that if the location of the first object on the map is changed according to an operation by the user, the changed location of the first object is transmitted to the management server 10, and the dispatch manager 53 of the management server 10 may be configured such that a new recommended boarding location that is recommended as the boarding location of the user is set on the basis of at least the changed location of the first object that has been received. In this case, the dispatch manager 53 may be configured to transmit the set recommended boarding location to the user terminal 30, and the dispatch request controller 55 of the user terminal 30 may be configured to move the first object from the changed location (changed according to an operation by the user) to the recommended boarding location received from the management server 10, in the map display area included on the specific screen. In this case, the first object is configured such that, in moving from the changed location to the recommended boarding location, it moves along with an animation effect showing the path from the changed location to the recommended boarding location. This animation effect may be the same as or different from the above-mentioned animation effect used when the first object moves from the user's current location where the first object was initially disposed to the recommended boarding location. Such a configuration promotes the setting of an appropriate boarding location and allows the user to easily ascertain the recommended boarding location, even when the location of the first object is changed according to an operation by the user.

In this embodiment, the map display area may be configured such that a second object that tracks the user's current location is further disposed. Such a configuration helps the user ascertain his or her current location on the map.

The map display area may also be configured such that a third object is disposed to connect the first object used for specifying the boarding location and the second object that tracks the user's current location. This third object is configured as a linear or curved object, for example. Such a configuration helps the user ascertain the relative relation between his or her current location on the map and the boarding location (the direction/bearing of the boarding location) and, as a result, promotes a smooth arrival by the user at the boarding location.

The map display area may also be configured such that a fourth object is disposed to indicate the travel direction of a dispatched vehicle at the location of the first object. The travel direction of the dispatched vehicle is determined by the dispatch manager 53 of the management server 10 in the setting of the recommended boarding location (or the calculation of the estimated dispatch time), for example, and is transmitted to the user terminal 30 together with the recommended boarding location. Such a configuration helps the user ascertain the travel direction of the dispatched vehicle on the map and, as a result, promotes a smooth arrival by the user at the boarding location.

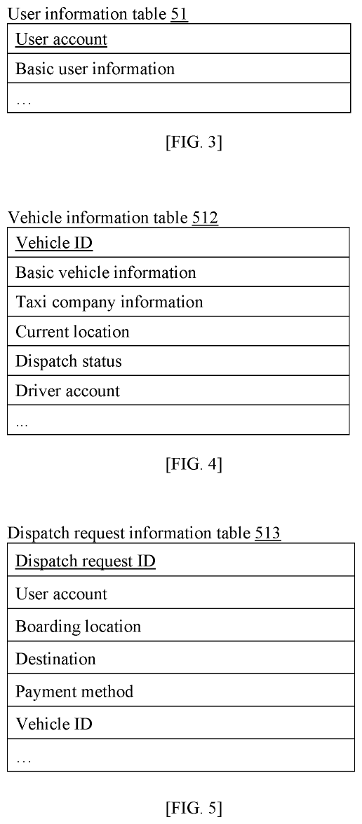

A specific example of the dispatch management system 1 of this embodiment having such functions will now be described. First, the information managed in the various tables in this example will be described. FIG. 3 shows an example of the information managed in a user information table 511. The user information table 511 manages information related to the users of the taxi dispatch service and, as shown in the drawing, manages information such as “basic user information,” which is associated with a “user account” that identifies an individual user. The basic user information includes, for example, name, contact information, payment information (credit card information, etc.), and so on.

FIG. 4 shows an example of the information managed in the vehicle information table 512. The vehicle information table 512 manages information related to each of the vehicles to be dispatched in the taxi dispatch service and, as shown in drawing, manages information such as “basic vehicle information,” “taxi company information,” “current location,” “dispatch status,” “driver account” (for identifying the corresponding driver), and so on, in association with a “vehicle ID” that identifies an individual vehicle. The basic vehicle information includes the vehicle make and model, the passenger capacity, an image (photograph or drawing) corresponding to the appearance of the vehicle, the license number, and so on. Location information transmitted from an information processing terminal or the like installed in the vehicle is set as the current location. Values corresponding to various states including “occupied,” “en route,” and “vacant” are set as the dispatch states.

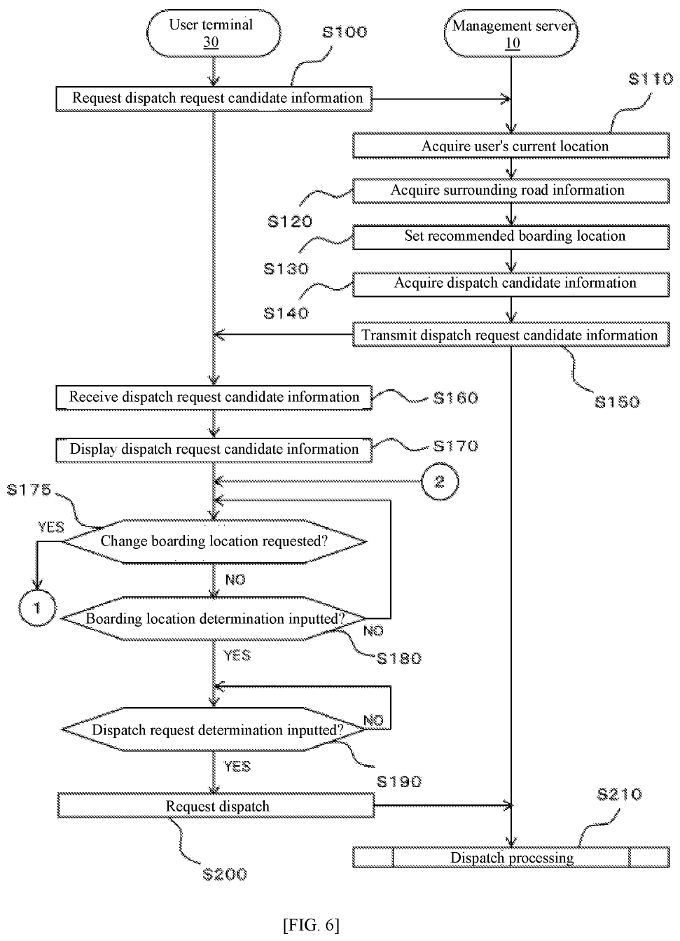

FIG. 5 shows an example of the information managed in the dispatch request information table 513. The dispatch request information table 513 manages information related to dispatch requests from users and, as shown in drawing, manages information such as the “user account” that identifies the user who made the dispatch request, “boarding location,” “destination,” “payment method,” the “vehicle ID” that identifies the vehicle that has been dispatched, and so on, in association with the “dispatch request ID” that identifies an individual dispatch request.

Next, the processing executed by the dispatch management system 1 in this example will be described. FIG. 6 is a sequence diagram showing an example of the processing executed by the management server 10 and the user terminal 30. First, the user terminal 30 asks the management server 10 for dispatch request candidate information related to candidates for the dispatch request (Step S100). This request for dispatch request candidate information is performed along with the transmission of information related to the user's current location and, more specifically, is performed along with the transmission of information about the location of the user terminal 30. Also, in this example, the user terminal 30 requests the dispatch request candidate information in Step S100 in response to the launching of a taxi dispatch service application.

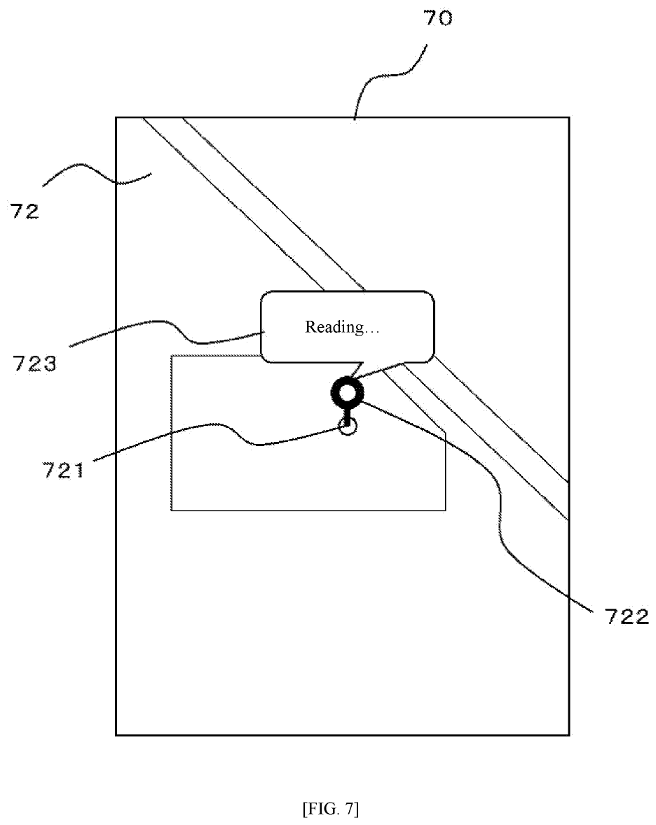

FIG. 7 shows an example of a boarding location setting screen 70 (specific screen) that is displayed on the user terminal 30 in response to the launch of the taxi dispatch service application. As shown in the drawing, the boarding location setting screen 70 is configured such that the entire screen is a map display area 72 in which a map is displayed, and in this area 72 are disposed a current location object (second object) 721 that is circular and tracks the current location of the user (the user terminal 30), a boarding location object (first object) 722 that is pin-shaped and is used for specifying the user's boarding location, and a message display object 723 that is balloon-shaped and is disposed above the object 722.

In the initial display of the boarding location setting screen 70, a map with a specific range based (centered) on the user's current location is displayed in a specific scale in the map display area 72. Therefore, the current location object 721 is disposed in the center of the map display area 72. Also, the boarding location object 722 is disposed in the center of the map display area 72, as is the current location object 721. In other words, the boarding location object 722 used for specifying the boarding location is initially disposed at the user's current location. Also, in the initial display of the boarding location setting screen 70, a message of “Reading . . . ” is displayed on the message display object 723 as shown in the drawing.

Returning to the sequence diagram of FIG. 6, the management server 10 that has received a request for dispatch request candidate information from the user terminal 30 then acquires the user's current location (Step S110), and acquires road information for a specific range surrounding the current location (Step S120). As discussed above, the user's current location is transmitted from the user terminal 30 together with a request for dispatch request candidate information. Also, information about the roads around the user's current location is acquired from the road map information database 515.

The management server 10 then sets the recommended boarding location that is recommended as the boarding location for the user (Step S130). More specifically, in this example, a location facing the roadway (link) closest to the user's current location is set as the recommended boarding location. In another example of this embodiment, candidates for boarding locations based on past setting results of boarding locations in the taxi dispatch service are set in advance (for example, they are set in the road map information database 515), and when there is a boarding location candidate within a specific range from the user's current location, that candidate is set as the recommended boarding location.

The management server 10 then acquires dispatch candidate information (specifying dispatch vehicle candidates, as well as estimating dispatch time) (Step S140). More specifically, of the vehicles that are vacant, the one closest to the recommended boarding location is specified as a candidate for a dispatch vehicle, and the dispatch time until the specified vehicle arrives at the recommended boarding location is estimated. The estimation of the dispatch time is performed through a known route search using the current location of the dispatch vehicle candidate as the departure point and the recommended boarding location as the destination.

The management server 10 then transmits the set recommended boarding location, the travel direction of the dispatched vehicle at that recommended boarding location, and the estimated dispatch time to the user terminal 30 as dispatch request candidate information (Step S150). The travel direction of the dispatched vehicle is acquired through the above-mentioned route search.

Subsequently, the user terminal 30 receives the dispatch request candidate information transmitted from the management server 10 (Step S160) and displays the dispatch request candidate information (Step S170). The dispatch request candidate information is displayed on the boarding location setting screen 70.

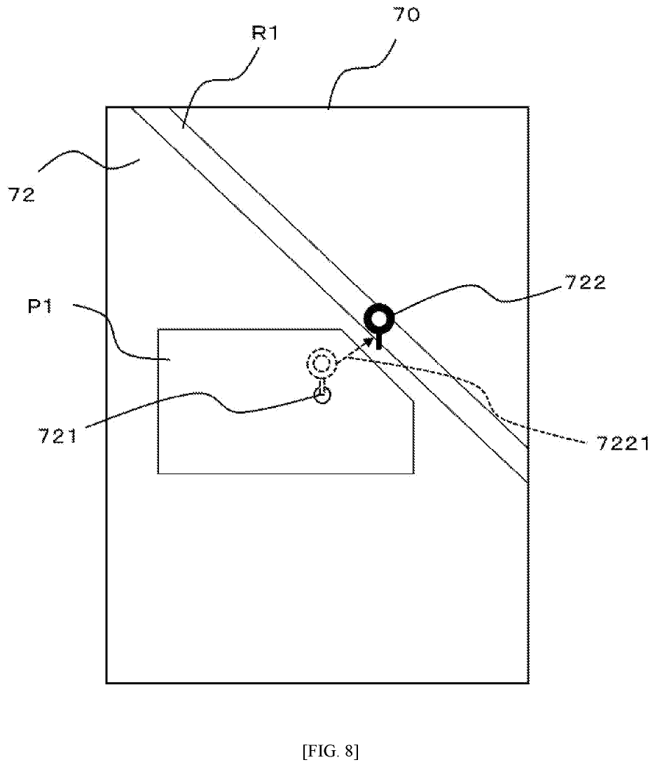

Here, from among the dispatch request candidate information, the recommended boarding location is displayed through the movement of the boarding location object 722. FIG. 8 is a diagram illustrating how the boarding location object 722 moves on the boarding location setting screen 70 in response to the receipt of dispatch request candidate information. More specifically, the boarding location object 722 moves from the user's current location (the location of the current location object 721, the center of the map display area 72) to the recommended boarding location. The recommended boarding location in the example shown in FIG. 8 is a location facing the road R1 closest to the facility P1 where the user is located. Also, when the boarding location object 722 moves, the message display object 723 is not displayed.

Also, in this example, when the boarding location object 722 moves from the user's current location to the recommended boarding location, it is accompanied by an animation display that moves along a linear path whose starting point is the user's current location and whose end point is the recommended boarding location (the path 7221 in FIG. 8). The movement of the boarding location object 722 with this animation effect allows the user to intuitively ascertain the recommended boarding location.

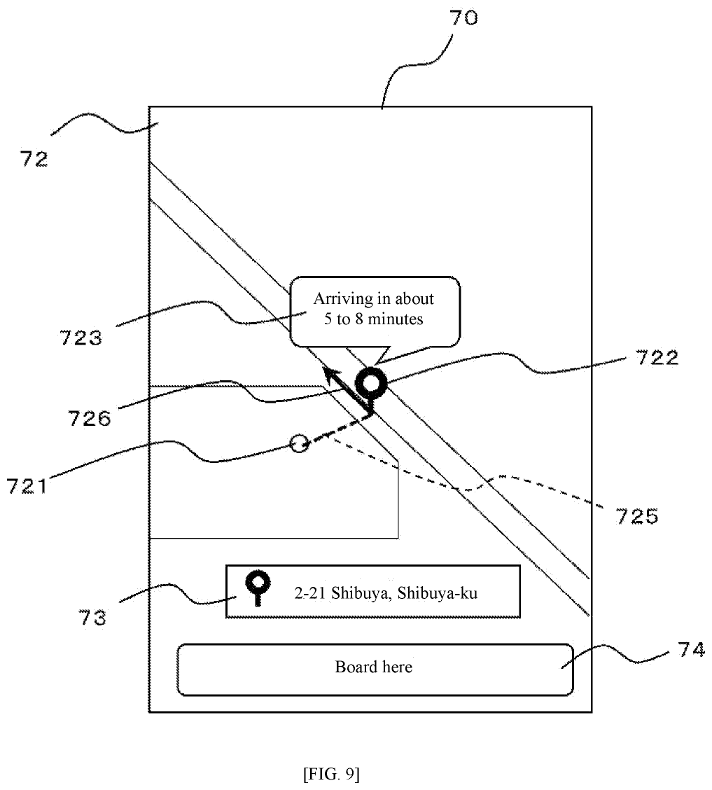

FIG. 9 shows an example of the boarding location setting screen 70 in a state in which the boarding location object 722 has moved to the recommended boarding location. As shown in the drawing, the screen 70 in this state is such that an address information display area 73 for displaying the address corresponding to the location of the boarding location object 722, and a boarding location determination object 74 displayed as “board here” are disposed one above the other at the bottom part of the map display area 72.

Also, in the boarding location setting screen 70 in this state, as shown in FIG. 9, the range over which the map displayed is automatically slid so that the boarding location object 722 (that is, the recommended boarding location) will be located in the center of the map display area 72. Also, the message display object 723 that was not displayed during movement of the boarding location object 722 is displayed again, and the estimated dispatch time included in the dispatch request candidate information received from the management server 10 is displayed in this object 723. The estimated dispatch time in this example is set as a time (time range) having a specific breadth so that “Arrive in about 5 to 8 minutes” is displayed on the message display object 723 in FIG. 9.

Also, as shown in FIG. 9, a movement direction object 725 (third object), which is a straight, broken line linking the current location object 721 and the boarding location object 722, is disposed in the map display area 72 of the boarding location setting screen 70 in this state. The user can intuitively ascertain the direction/orientation of the recommended boarding location with reference to the user's current location by using this movement direction object 725.

Also, an arrow-shaped vehicle travel direction object 726 (fourth object) is disposed at the base of the pin-shaped boarding location object 722 in the map display area 72 of the boarding location setting screen 70 in this state. This object 726 is disposed so as to extend from the base of the boarding location object 722 in the travel direction of the dispatched vehicle. The travel direction of the dispatched vehicle is included in the dispatch request candidate information received from the management server 10.

Thus, in this example, the recommended boarding location, the travel direction of the dispatched vehicle, and the estimated dispatch time, which are the dispatch request candidate information received from the management server 10, are displayed on the boarding location setting screen 70 via the boarding location object 722, the vehicle travel direction object 726, and the message display object 723. The user takes this information into account to determine whether or not to request a vehicle dispatch at this recommended boarding location.

Returning to the sequence diagram of FIG. 6, the user terminal 30 then waits for boarding location determination input to be performed by the user (No in Step S180), unless a boarding location change request has been made by the user (No in Step S175). More specifically, the user terminal 30 waits for the boarding location determination object 74 to be selected. The boarding location change request made by the user will be described below.

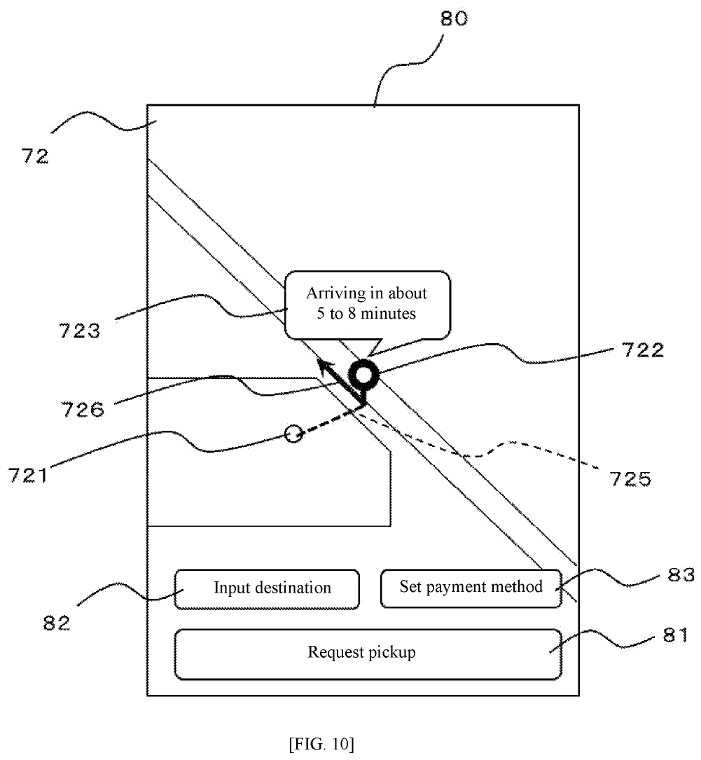

If boarding location determination input has been performed (Yes in Step S180), the user terminal 30 then waits for dispatch request determination input by the user (No in Step S190). FIG. 10 shows an example of the dispatch request screen 80 displayed on the user terminal 30 in response to the selection of the boarding location determination object 74 by the user (boarding location determination input). This screen 80 has a map display area 72 that is the same as on the boarding location setting screen 70. Also, a dispatch request determination button 81 displayed as “Request pickup,” a destination input button 82 displayed as “Input destination,” and a payment method setting button 83 displayed as “Set payment method” are disposed at the bottom part of the map display area 72 on the dispatch request screen 80. The user inputs a dispatch request determination by selecting the dispatch request decision button 81. The user can set the taxi destination (target location) in advance (before requesting dispatch) through selection of the destination input button 82, and can also set the payment method in advance (before requesting dispatch) by selecting the payment method setting button 83.

Returning to the sequence diagram of FIG. 6, when a dispatch request determination is inputted (Yes in Step S190), the user terminal 30 makes a dispatch request to the management server 10 (Step S200). More specifically, a dispatch request is transmitted to the management server 10 along with the boarding location specified via the boarding location object 722.

Then, once the management server 10 has received the dispatch request, it executes specific dispatch processing (Step S210). This specific dispatch processing includes, for example, processing for specifying the vehicle to be assigned to a dispatch request (for example, the vehicle specified in the acquisition of dispatch candidate information in Step S140 is usually assigned), and transmitting dispatch request information (boarding location, basic user information, destination, payment method, etc.) to the information processing terminal operated by the driver of the specified vehicle, and processing for receiving a response to the dispatch request from the driver who received the dispatch request (“Accept” or “Decline,” etc.), concluding that dispatch has been confirmed if the driver's response is “Accept,” and transmitting a message to that effect to the user terminal 30, or assigning another taxi if the driver's response is “Decline.” Since this dispatch processing is standard practice for operators in this industry, it will not be described in further detail here.

The operation when the user changes the boarding location will now be described. In this example, the user can change the boarding location via the boarding location setting screen 70. More specifically, the map display area 72 of the boarding location setting screen 70 is configured such that the range of the map displayed in the area 72 may be slid by a slide operation or the like of a portion where no objects (such as the boarding location determination object 74) are disposed or displayed, while the boarding location object 722 is fixed at the center of the map display area 72. That is, the user can change the location of the boarding location object 722 on the map by changing the range of the map displayed in the map display area 72.

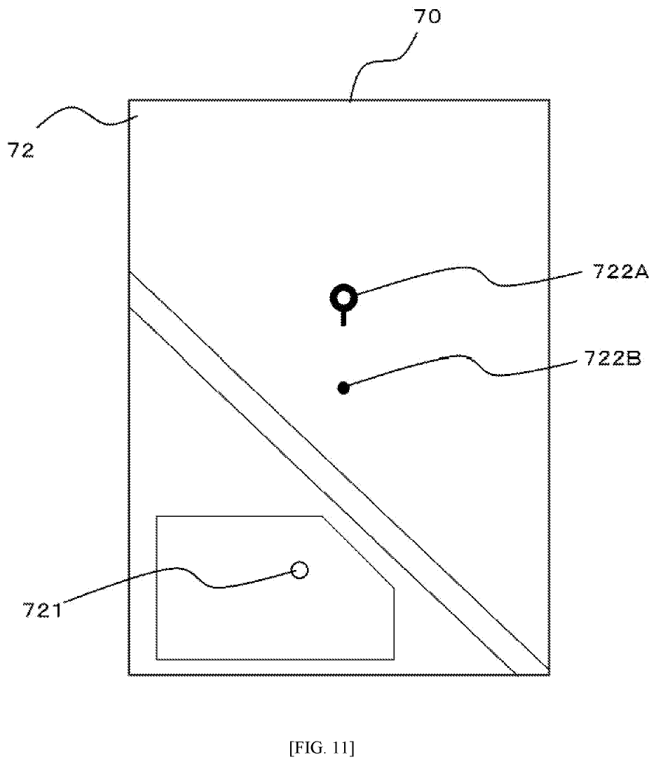

FIG. 11 shows an example of the boarding location setting screen 70 in a state in which the user is in the midst of an operation to change the range of the map displayed in the map display area 72 (such as a state in which the touch state on the touch panel is being maintained). As shown in the drawing, the screen 70 in this state is such that the address information display area 73 and the boarding location determination object 74 are not displayed, and in the map display area 72, the message display object 723, the movement direction object 725, and the vehicle travel direction object 726 are not displayed. Also, the boarding location object 722 is separated into a pin-shaped first object 722A and a circular (dotted) second object 722B, with the second object 722B disposed in the center of the map display area 72 corresponding to the changed boarding location, with the first object 722A disposed at a location that is a specific distance above the second object 722B. The user adjusts the display range of the map in the map display area 72 so that the location of the second object 722B (that is, the center of the map display area 72) will be in the desired location for the boarding location.

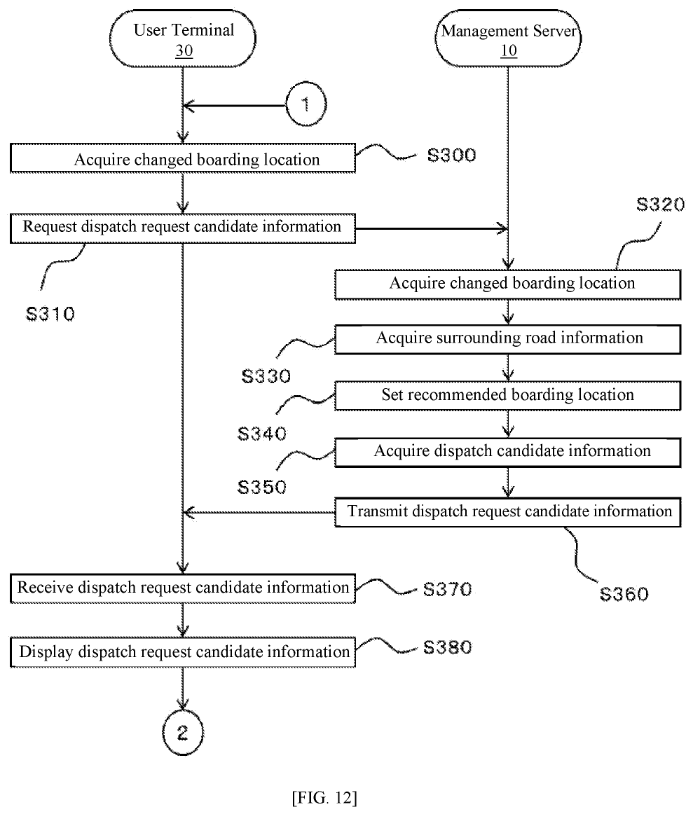

When the operation of changing the display range of the map in the map display area 72 is complete (such as when the touch state on the touch panel is canceled), the boarding location change request is confirmed. Returning to the sequence diagram of FIG. 6, when a request for changing the boarding location is made (Yes in Step S175), the user terminal 30 acquires the changed boarding location as shown in the sequence diagram of FIG. 12 (Step S300), and sends the management server 10 a request for dispatch request candidate information (Step S310). The changed boarding location is acquired by specifying the location on the map corresponding to the center of the map display area 72 that is the location of the boarding location object 722 (second object 722B). Also, the request for dispatch request candidate information is made along with the transmission of the information related to the changed boarding location.

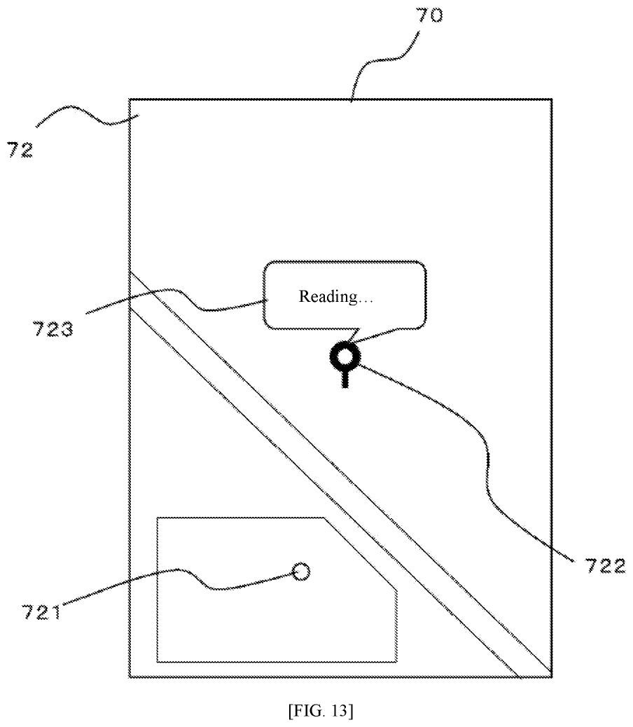

FIG. 13 shows an example of the boarding location setting screen 70 in a state in which a change of the boarding location has been requested (that is, the operation to change the display range of the map in the map display area 72 is complete). In the map display area 72 of the screen 70 in this state, the first object 722A and the second object 722B, which had been separated in a state where the display range of the map was in the midst of being changed in the map display area 72, are combined into the boarding location object 722 (the first object 722A drops down and merges with the second object 722B). Also, a message display object 723 for displaying a message “Reading . . . ” is disposed.

Returning to the sequence diagram of FIG. 12, upon receiving the request for dispatch request candidate information from the user terminal 30, the management server 10 next acquires the changed boarding location (Step S320) as well as road information for a specific range around this changed boarding location (Step S330). The changed boarding location is transmitted from the user terminal 30 along with a request for dispatch request candidate information. Also, road information for the area around the changed boarding location is acquired from the road map information database 515.

The subsequent processing is the same as when the taxi dispatch service application is launched (at the initial display of the boarding location setting screen 70). First, the management server 10 sets a recommended boarding location that is recommended as the boarding location for the user (Step S340). More specifically, a location facing the roadway (link) closest to the changed boarding location is determined as the recommended boarding location.

The management server 10 then acquires dispatch candidate information (specification of dispatch vehicle candidates and dispatch time estimation) (Step S350). More specifically, of all the vehicles that are vacant, the vehicle that is the shortest distance from the recommended boarding location is specified as a candidate for a dispatch vehicle, and the dispatch time until the specified vehicle arrives at the recommended boarding location is estimated. The dispatch time is estimated through a route search in which the current location of the candidate for the dispatch vehicle serves as the starting point and the recommended boarding location serves as the destination.

The management server 10 then transmits the set recommended boarding location, the travel direction of the dispatched vehicle at the recommended boarding location, and the estimated dispatch time to the user terminal 30 as dispatch request candidate information (Step S360). The travel direction of the dispatched vehicle is acquired through the route search mentioned above.

The user terminal 30 then receives the dispatch request candidate information transmitted from the management server 10 (Step S370), and displays this dispatch request candidate information (Step S380). After this, the user terminal 30 returns to standby for boarding location determination input from the user (No in Step S180) (see the sequence diagram of FIG. 6).

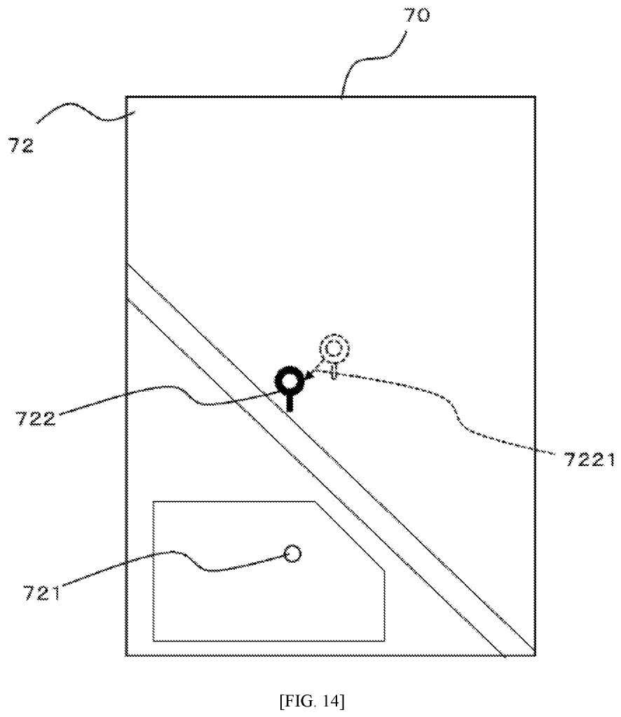

FIG. 14 is a diagram illustrating how the boarding location object 722 moves on the boarding location setting screen 70 in response to reception of the dispatch request candidate information. More specifically, the boarding location object 722 moves from the location changed by the user (the center of the map display area 72) to the recommended boarding location. When the boarding location object 722 moves, the message display object 723 is not displayed.

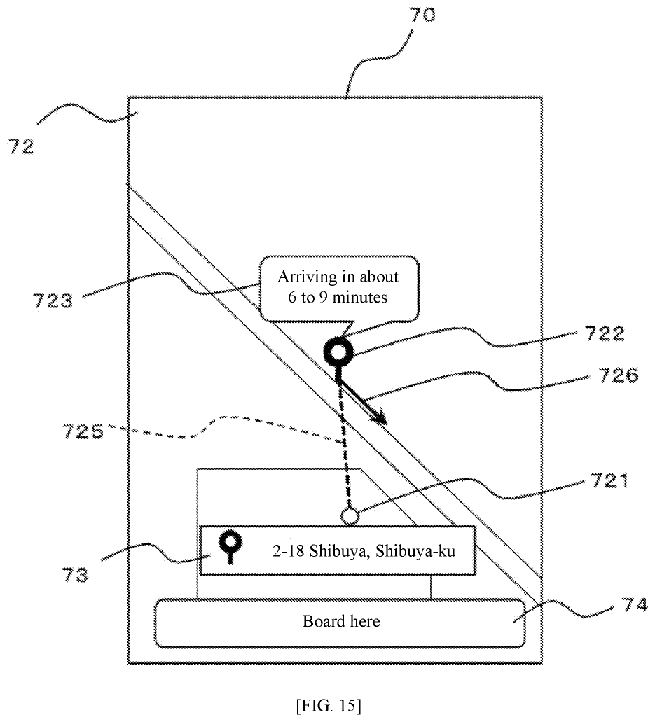

In the movement of boarding location object 722 to the recommended boarding location, an animation display is given that has a linear path (the path 7221 in FIG. 14) that starts from the location changed by the user (the center of the map display area 72) and ends at the recommended boarding location. This movement of the boarding location object 722 with an animation effect allows the user to intuitively ascertain the recommended boarding location. When the movement of the boarding location object 722 to the recommended boarding location is complete, the boarding location setting screen 70 gives the display illustrated in FIG. 15 and, just as in the initial display of the screen 70, the recommended boarding location, the travel direction of the dispatched vehicle, and the estimated dispatch time are displayed via the boarding location object 722, the vehicle travel direction object 726, and the message display object 723 as the dispatch request candidate information received from the management server 10.

Thus, in this example, when the taxi dispatch service application is launched (when the boarding location setting screen 70 is initially displayed), and when the boarding location is changed according to the operation by the user, the management server 10 sets the recommended boarding location. However, in another example of this embodiment, when the boarding location is changed according to an operation by the user, for example, the recommended boarding location is not set and the changed boarding location is used as it is. In this case, the user terminal 30 may be prohibited from changing the boarding location to an inappropriate area, or a warning may be issued for this change.

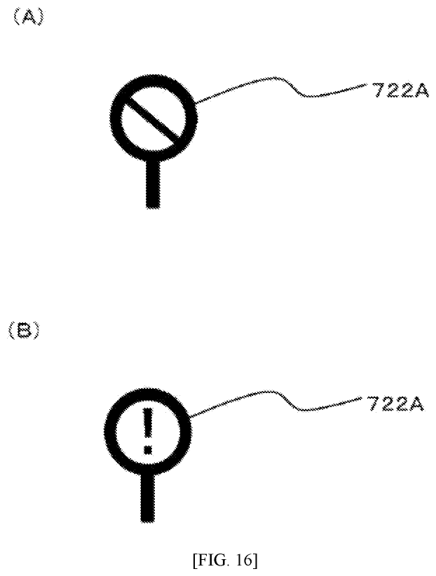

For instance, in a state in which the display range of the map in the map display area 72 of the boarding location setting screen 70 is in the midst of being changed, if the location of the second object 722B is within a specific prohibited area (first area) (such as in the middle of an intersection, or a road with a guardrail), the appearance of the first object 722A that has separated from the boarding location object 722 will show as a prohibited display, whereby a slanted line is drawn through the inside of the upper circular portion, as shown in FIG. 16(A). Similarly, if the location of the second object 722B is within a specific warning area (second area) (such as a road with a steep grade), the appearance of the first object 722A will show as a warning display, whereby an exclamation mark is displayed inside the upper circular portion, as shown in FIG. 16B. If a change of the display range of the map in the map display area 72 (that is, the change of the boarding location) is completed in a state in which the location of the second object 722B is within a specific prohibited area, the system will forcibly revert to the state prior to the start of this change, but if a change of the display range of the map is completed in a state in which the location of the second object 722B is within a specific warning area, the change of the boarding location itself will be applied.

In the above example, the configuration was such that, by changing the range of the map displayed in the map display area 72 of the boarding location setting screen 70, the location of the boarding location object 722 on the map in a fixed display at the center of the area 72 was changed, but this embodiment is not limited to such a mode and, in another example of this embodiment, the map display area 72 is configured such that the location in the map display area 72 of the boarding location object 722 itself is changed according to an operation by the user.

With the dispatch management system 1 according to the embodiment described above, since the recommended boarding location is set on the basis of the user's current location, the setting of an appropriate boarding location is promoted, and furthermore, a first object for specifying the boarding location (such as the boarding location object 722) is initially displayed at the user's current location in the map display area of a specific screen presented to the user (such as the boarding location setting screen 70), and this object moves along with an animation effect showing the path from the user's current location to the recommended boarding location, so the user can easily ascertain the recommended boarding location. As a result, this helps provide smooth boarding of the dispatched vehicle.

In another embodiment of the present invention, the management server 10 is constituted by a plurality of servers distributed by function. For example, it can be constituted by a dispatch management server, a road map information server, a route search server, and a route guidance server.

In addition to what was explicitly described above, the processing and procedures described in this Specification can be implemented by software, hardware, or any combination thereof. For example, the processing and procedures described in this Specification can be realized by mounting logic devices corresponding to the processing and procedures on a medium such as an integrated circuit, a volatile memory, a nonvolatile memory, or a magnetic disk. The processing and procedures described in this Specification can be implemented as a computer program corresponding to the processing and procedures, and executed by various kinds of computers.

Although the processing and procedures described in this Specification were described as being executed by a single device, software, component, or module, such processing or procedures may be performed by a plurality of devices, a plurality of pieces of software, a plurality of components, and/or a plurality of modules. Also, the software and hardware elements described in this Specification can be merged into fewer constituent elements, or broken up into more constituent elements.

In this Specification, whether the constituent elements of the invention are described as being singular or plural, or are described without being limited to singular or plural, these constituent elements may be either singular or plural, unless otherwise dictated by context.

### DESCRIPTION OF THE REFERENCE NUMERALS

1 Dispatch management system
10 Management server
11 Computer processor
20 Communication network
30 User terminal
31 Computer processor
51 Information storage manager
52 Basic function controller
53 Vehicle dispatch manager
54 Information storage manager
55 Dispatch request controller
70 Boarding location setting screen (specific screen)
80 Dispatch request screen
72 Map display area
721 Current location object (second object)
722 Boarding location object (first object)
723 Message display object
725 Movement direction object (third object)
726 Vehicle travel direction object (fourth object)

1. A system for managing taxi dispatch, comprising one or more computer processors,
wherein the one or more computer processors, in response to the execution of readable commands, execute processing for:
presenting a user with a specific screen having a map display area in which is disposed a first object that is used for specifying the user's boarding location and that is initially disposed at the user's current location;
setting a first recommended boarding location that is recommended as the user's boarding location on the basis of at least the user's current location, and moving the first object from the user's current location to the first recommended boarding location in the map display area;
receiving from the user a taxi dispatch request in which the location of the first object is used as the user's boarding location; and
performing specific dispatch processing in response to the receipt of the dispatch request, and
the processing for moving the first object to the first recommended boarding location includes moving the first object along with an animation effect showing the path from the user's current location to the first recommended boarding location.

2. The system according to claim 1,
wherein the one or more computer processors further execute processing for calculating the estimated dispatch time estimated as the dispatch time required to dispatch a taxi to the first recommended boarding location, on the basis of at least the first recommended boarding location, and
the processing for moving the first object to the first recommended boarding location includes displaying the estimated dispatch time on the specific screen along with the movement of the first object.

3. The system according to claim 1,
wherein the one or more computer processors further execute processing for changing the location of the first object on the map in response to a user operation on the specific screen.

4. The system according to claim 3,
wherein the processing for changing the location of the first object includes disabling a change of the location of the first object when the changed location of the first object is included in a first area.

5. The system according to claim 3,
wherein the processing for changing the location of the first object includes issuing a specific warning to the user when the changed location of the first object is included in a second area.

6. The system according to claim 3,
wherein the one or more computer processors further execute processing for setting a second recommended boarding location that is recommended as the user's boarding location on the basis of at least the changed location of the first object in response to a change to the location of the first object, and moving the first object from the changed location of the first object to the second recommended boarding location in the map display area, and
the processing for moving the first object to the second recommended boarding location includes an animation effect showing the path from the changed location of the first object to the second recommended boarding location.

7. The system according to claim 1,
wherein the map display area is configured such that a second object that tracks the user's current location is further disposed.

8. The system according to claim 7,
wherein the map display area is configured such that a third object linking the first object and the second object is further disposed.

9. The system according to claim 1,
wherein the map display area is configured such that a fourth object indicating the travel direction of a dispatched vehicle at the location of the first object is further disposed.

10. A method for managing taxi dispatch, which is executed by one or more computers, said method comprising the steps of:
presenting a user with a specific screen having a map display area in which is disposed a first object that is used for specifying the user's boarding location and that is initially disposed at the user's current location;
setting a first recommended boarding location that is recommended as the user's boarding location on the basis of at least the user's current location, and moving the first object from the user's current location to the first recommended boarding location in the map display area;
receiving from the user a taxi dispatch request in which the location of the first object is used as the user's boarding location; and
performing specific dispatch processing in response to the receipt of the dispatch request, and
the step of moving the first object to the first recommended boarding location includes moving the first object along with an animation effect showing the path from the user's current location to the first recommended boarding location.

11. A non-transitory computer readable medium storing instructions for controlling taxi dispatch requests, said instructions, in response to being executed on one or more computers, causing the one or more computers to execute processing for:
presenting a user with a specific screen having a map display area in which is disposed a first object that is used for specifying the user's boarding location and is that initially disposed at the user's current location;
moving the first object in the map display area from the user's current location to a first recommended boarding location that is recommended as the user's boarding location and that is set on the basis of at least the user's current location; and
receiving from the user a taxi dispatch request in which the location of the first object is used as the user's boarding location,
wherein the processing for moving the first object to the first recommended boarding location includes moving the first object along with an animation effect showing the path from the user's current location to the first recommended boarding location.
